(19) United States
(12) Patent Application Publication
(10) Pub. No.: US 2025/0217532 A1
(43) Pub. Date: Jul. 3, 2025

(54) METHOD FOR GENERATING AN ATTACHMENT IN A LOGICAL TOPOLOGY DIAGRAM AND DEVICE

(71) Applicant: Persagy Science and Technology Co.,Ltd, Beijing (CN)

(72) Inventors: Qi SHEN, Beijing (CN); Xiaoyan PAN, Beijing (CN); Ting HAN, Beijing (CN); Lu MENG, Beijing (CN); Feifei LIU, Beijing (CN); Xuening Zhang, Beijing (CN)

(21) Appl. No.: 18/886,677

(22) Filed: Sep. 16, 2024

(30) Foreign Application Priority Data
Dec. 28, 2023 (CN) 202311837375.9
Dec. 28, 2023 (CN) 202311837387.1

(51) Int. Cl. G06F 30/13; G06T 11/20

(52) U.S. Cl. CPC G06F 30/13; G06T 11/203

(57) ABSTRACT

Provided are a method for generating an attachment in a logical topology diagram and a device. The method includes the steps described below. Physical world data of a target building is acquired, and a target relationship diagram template is determined from pre-built candidate relationship diagram templates according to the physical world data and a topology diagram generation requirement; connecting line information of a graphic element in the logical topology diagram is determined according to the target relationship diagram template; and attachment information in the logical topology diagram is generated according to template attachment information in the target relationship diagram template and the connecting line information of the graphic elements.

### CROSS-REFERENCE TO RELATED APPLICATION

This application claims priority to Chinese Patent Application No. 202311837387.1, filed on Dec. 28, 2023 and Chinese Patent Application No. 202311837375.9, filed on Dec. 28, 2023, the disclosures of which are incorporated herein by reference in their entireties.

### TECHNICAL FIELD

The present disclosure relates to the field of software engineering, in particular, to a method for generating an attachment in a logical topology diagram and a device.

### BACKGROUND

In intelligent systems related to infrastructure such as architecture, municipal engineering and transportation, system diagrams are widely used for expressing the composition structure and the operating state of an electromechanical system. Common system diagrams include distribution system diagrams, heating station system diagrams and cold source system diagrams. A system diagram is presented through a two-dimensional diagram, where specific physical connection relationships between graphics are expressed through connecting lines between the graphics, and thus the graphic composition of a complete system is drawn, and the system diagram is referred to as a “logical topology diagram”.

In a logical topology diagram, rectangles of various sizes represent different physical objects such as devices, systems and spaces, are referred to as graphic elements. The graphic elements are connected by polylines, and these polylines represents pipeline and line connection relationships or subordination relationships between the graphic elements. In addition, there will also be small graphic elements on connecting lines representing accessory devices on connecting pipelines between devices, such as temperature sensors, pressure sensors, electric valves, manual valves and filters.

Attachments in logical topology diagrams need to be manually determined by engineers in the professional domain and cannot be automatically generated, resulting in low efficiency in generating attachments in logical topology diagrams.

### SUMMARY

The present disclosure provides a method and apparatus for generating an attachment in a logical topology diagram and a device. According to the technical solutions of the present disclosure, the attachment type in the logical topology diagram is determined based on the relationship level classification, the positioning point of the attachment in the logical topology diagram is determined according to the information related to the attachment, and then positioning of the attachment in the logical topology diagram is implemented.

According to another aspect of the present disclosure, a method for generating an attachment in a logical topology diagram is provided. The method includes the steps described below.

Physical world data of a target building is acquired, and a target relationship diagram template is determined from pre-built candidate relationship diagram templates according to the physical world data and a topology diagram generation requirement, where the physical world data includes at least complete relationship representation information of spaces, systems and devices in the target building.

Connecting line information of a graphic element in the logical topology diagram is determined according to the target relationship diagram template.

Attachment information in the logical topology diagram is generated according to template attachment information in the target relationship diagram template and the connecting line information of the graphic elements, where the attachment refers to a graphic element attached to a connecting line of at least two graphic elements of the graphic elements and is used for representing an accessory device on a connecting pipeline between physical objects corresponding to the at least two graphic elements.

According to another aspect of the present disclosure, a line connection method of graphic elements in a logical topology diagram is provided. The method includes the steps described below.

Physical world data of a target building is acquired, and a target relationship diagram template is determined from pre-built candidate relationship diagram templates according to the physical world data and a topology diagram generation requirement, where the physical world data includes at least complete relationship representation information of spaces, systems and devices in the target building.

Connection relationships of graphic elements and position information of the graphic elements in the logical topology diagram are determined according to the target relationship diagram template.

Connecting line information of the graphic elements is determined according to the connection relationships of the graphic elements and the position information of the graphic elements.

According to another aspect of the present disclosure, an apparatus for generating an attachment in a logical topology diagram is provided. The apparatus includes a relationship diagram template determination module, a connecting line information determination module and an attachment information generation module.

The relationship diagram template determination module is configured to acquire physical world data of a target building, and determine a target relationship diagram template from pre-built candidate relationship diagram templates according to the physical world data and a topology diagram generation requirement, where the physical world data includes at least complete relationship representation information of spaces, systems and devices in the target building.

The connecting line information determination module is configured to determine connecting line information of graphic elements in the logical topology diagram according to the target relationship diagram template.

The attachment information generation module is configured to generate attachment information in the logical topology diagram according to template attachment information in the target relationship diagram template and the connecting line information of the graphic elements, where the attachment refers to a graphic element attached to a connecting line of at least two graphic elements of the graphic elements and is used for representing an accessory device on a connecting pipeline between physical objects corresponding to the at least two graphic elements.

According to another aspect of the present disclosure, a line connection apparatus of graphic elements in a logical topology diagram is provided. The apparatus includes a relationship diagram template determination module, a connection relationship and position determination module and a connection information determination module.

The relationship diagram template determination module is configured to acquire physical world data of a target building, and determine a target relationship diagram template from pre-built candidate relationship diagram templates according to the physical world data and a topology diagram generation requirement, where the physical world data includes at least complete relationship representation information of spaces, systems and devices in the target building.

The connection relationship and position determination module is configured to determine connection relationships of graphic elements and position information of the graphic elements in the logical topology diagram according to the target relationship diagram template.

The connection information determination module is configured to determine connecting line information of the graphic elements according to the connection relationships of the graphic elements and the position information of the graphic elements.

According to another aspect of the present disclosure, an electronic device is provided and includes at least one processor and a memory communicatively connected to the at least one processor.

The memory stores a computer program executable by the at least one processor, and the computer program is executed by the at least one processor to cause the at least one processor to perform the method for generating an attachment in a logical topology diagram according to any embodiment of the present disclosure.

According to another aspect of the present disclosure, a computer-readable storage medium is provided. The computer-readable storage medium is configured to store computer instructions configured to, when executed by a processor, cause the processor to perform the method for generating an attachment in a logical topology diagram according to any embodiment of the present disclosure.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

To illustrate the technical solutions of the embodiments of the present disclosure more clearly, the drawings used in the description of the embodiments are described briefly hereinafter. Apparently, the drawings described below illustrate merely part of the embodiments of the present disclosure. Those of ordinary skill in the art may obtain other drawings based on these drawings on the premise that no creative work is done.

FIG. 1 is a flowchart of a method for generating an attachment in a logical topology diagram according to an embodiment of the present disclosure;

FIG. 2 is a diagram showing the logic for recognizing attachment relationships according to an embodiment of the present disclosure;

FIG. 3 is a diagram showing water supply connection relationships of water pump water supply pipelines according to an embodiment of the present disclosure;

FIG. 4 is a diagram showing positioning of an attachment of a graphic element representing a valve on a connecting line according to an embodiment of the present disclosure;

FIG. 5 is a diagram of a text display region according to an embodiment of the present disclosure;

FIG. 6 is a flowchart of a line connection method of graphic elements in a logical topology diagram according to an embodiment of the present disclosure;

FIG. 7 is a diagram showing right and wrong line connection logic applicable to embodiments of the present disclosure;

FIG. 8 is a diagram showing multiple graphic elements on the left and the right and multiple path lines according to an embodiment of the present disclosure;

FIG. 9 is a diagram showing the process of drawing auxiliary lines according to an embodiment of the present disclosure;

FIG. 10 is a diagram showing the connection of merged connecting lines according to an embodiment of the present disclosure;

FIG. 11 is another diagram showing the connection of merged connecting lines according to an embodiment of the present disclosure;

FIG. 12 is a routing diagram when devices are on a same side of merged connecting lines according to an embodiment of the present disclosure;

FIG. 13 is a routing diagram when devices are on two sides of merged connecting lines according to an embodiment of the present disclosure;

FIG. 14 is a structural diagram of an apparatus for generating an attachment in a logical topology diagram according to an embodiment of the present disclosure;

FIG. 15 is a structural diagram of a line connecting apparatus of graphic elements in a logical topology diagram according to an embodiment of the present disclosure; and

FIG. 16 is a structural diagram of an electronic device for implementing a method for generating an attachment in a logical topology diagram according to an embodiment of the present disclosure.

### DETAILED DESCRIPTION

For a better understanding of the solutions of the present disclosure by those skilled in the art, the technical solutions in the embodiments of the present disclosure are described clearly and completely below in conjunction with the drawings in the embodiments of the present disclosure. Apparently, the embodiments described below are merely part, not all, of the embodiments of the present disclosure. Based on the embodiments of the present disclosure, all other embodiments obtained by those of ordinary skill in the art on the premise that no creative work is done are within the scope of the present disclosure.

It is to be noted that the terms “candidate”, “target” and the like in the description, claims and the preceding drawings of the present disclosure are used for distinguishing between similar objects and are not necessarily used for describing a particular order or sequence. It is to be understood that the data used in this manner is interchangeable in appropriate cases so that the embodiments of the present disclosure described herein may be implemented in an order not illustrated or described herein. Additionally, terms “including” and “having” as well as any variations thereof are intended to encompass a non-exclusive inclusion. For example, a process, method, system, product or device that includes a series of steps or units not only includes the expressly listed steps or units but may also include other steps or units that are not expressly listed or are inherent to such a process, method, product or device.

### Embodiment One

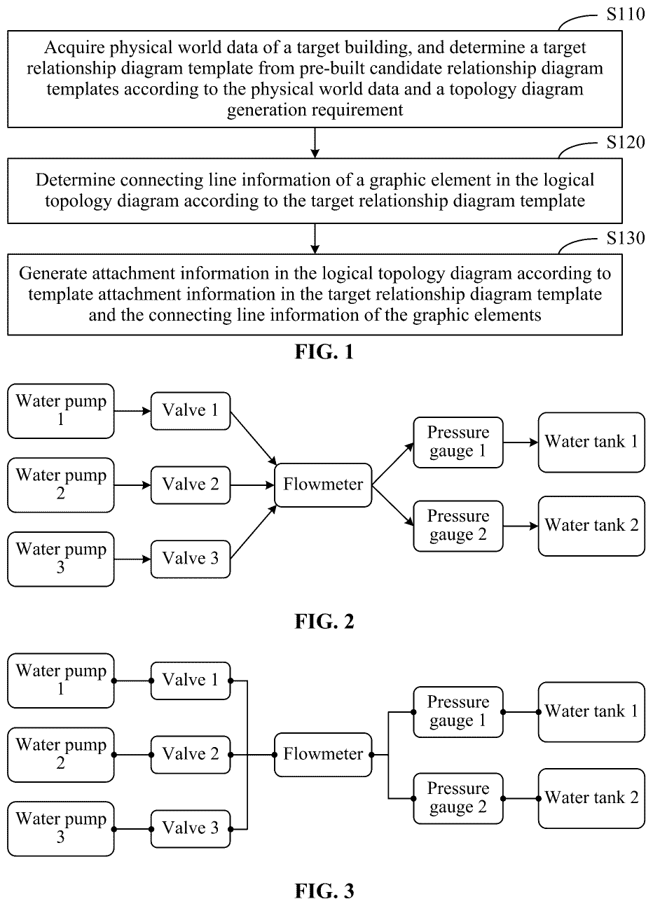

FIG. 1 is a flowchart of a method for generating an attachment in a logical topology diagram according to an embodiment of the present disclosure. The embodiment is applicable to the case of generating an attachment in a logical topology diagram. The method may be executed by an apparatus for generating an attachment in a logical topology diagram, which may be implemented in form of hardware and/or software and may be configured in a system computer. As shown in FIG. 1, the method includes the steps described below.

In S110, physical world data of a target building is acquired, and a target relationship diagram template is determined from pre-built candidate relationship diagram templates according to the physical world data and a topology diagram generation requirement, where the physical world data includes at least complete relationship representation information of spaces, systems and devices in the target building.

In the embodiment of the present application, the target building refers to a specific building entity in the engineering field. The physical world data of the target building may be understood as the digital form of the target building and refers to the complete expression of objective physical information of a physical building, including spaces, systems, device objects, information points and relationship data in the physical building. The complete relationship representation information of devices includes two aspects, that is, device object information points and connection relationship data of device objects, respectively.

It is to be noted that the topology diagram generation requirement refers to the type of the logical topology diagram to be generated according to the needs of the user. The layout and display parameters of the logical topology diagram are part of the personalized display requirement of the generation requirement, including an image dimension requirement and whether a graphic element is specified to be displayed or hidden.

The candidate relationship diagram templates are standardized representation of a certain type of electromechanical systems and devices, including professional attribute information of composition, connection relationships and layout expression of specific electromechanical systems. This type of candidate relationship diagram templates are pre-stored in a database by the system for calling, and a target relationship diagram template type is determined from the candidate relationship diagram templates according to the specific data of the target building and the layout and display parameters of the topology diagram.

In S120, connecting line information of a graphic element in the logical topology diagram is determined according to the target relationship diagram template.

In the embodiment of the present application, graphic elements are represented by rectangles of various sizes, representing different physical objects such as devices, systems and spaces. The graphic elements are connected by polylines, and these polylines represents pipelines, line connection relationships or subordination relationships between physical objects. The position information of each graphic element in the target relationship diagram template is laid out and typeset relative to other graphic elements, and the final positioning result of the position information is relative position relationships between graphic elements. Line connection is performed between various graphic elements in the entire template in blank regions between graphic elements through the determined relative position relationships and connection relationships of graphic elements.

The connecting line information of the graphic elements in the logical topology diagram includes connection relationships between graphic elements, as well as line trend and position information of connecting lines. The connecting line information is determined by the relative position relationships and connection relationships of graphic elements.

In S130, attachment information in the logical topology diagram is generated according to template attachment information in the target relationship diagram template and the connecting line information of the graphic elements, where the attachment refers to a graphic element attached to a connecting line of at least two graphic elements of the graphic elements and is used for representing an accessory device on a connecting pipeline between physical objects corresponding to the at least two graphic elements.

In the embodiment of the present application, the attachment in the logical topology diagram is represented by a relatively small graphic element and is an accessory device on a connecting pipeline between devices in the physical world data. The attachment may be, for example, a temperature sensor, a pressure sensor, an electric valve, a manual valve or a filter. The graphic element corresponding to the accessory device has the characteristics described below.

Compared to rectangular blocks representing conventional devices, systems and spaces, the rectangular block representing the graphic element corresponding to the accessory device is much smaller.

The location of the graphic element is attached to the connecting line.

No strict position constraint exists for the location of the graphic element.

In an optional but not limited implementation, the step in which the attachment information in the logical topology diagram is generated according to the template attachment information in the target relationship diagram template and the connecting line information of the graphic elements includes steps A1 and A2.

In step A1, matched target attachment data is determined from the physical world data according to an attachment screening condition in the template attachment information in the target relationship diagram template.

In step A2, the attachment information in the logical topology diagram is generated according to the target attachment data and the connecting line information of the graphic elements.

In the embodiment of the present application, the template attachment information includes the attachment screening condition, and the attachment screening condition is used for screening a target attachment matching the physical object in the physical world data. The target attachment obtained through screening matches the accessory device on the connecting pipeline in the physical world data, and the target attachment data is an attachment matching the screening condition in the physical world data. The attachment generation in the logical topology diagram includes attachment screening and attachment positioning. Attachment screening includes static information point screening, and attachment positioning is determined by connection relationships between graphic elements, as well as line trend and position information of connecting lines. For example, the attachment screening condition may be model screening information of an attachment.

In an optional but not limited implementation, the attachment screening condition includes a static information point screening condition. The static information point screening condition includes at least one of the following logical combinations of data logic: an information point value being null or non-null, an information point value being a Boolean value, an information point value being an enumerated value, an information point value being a numerical value or an information point value being a character value.

In the embodiment of the present application, screening performed on static information points of the accessory device in the physical world data refers to screening performed on attribute information of the graphic element corresponding to the attachment in the relationship diagram template. The static information points are used for representing the attribute information of the physical object represented by the graphic element, such as the manufacturer, the power, and other attribute information that will not change with the operating state of the physical object.

In an embodiment, static information point includes four types, that is, Boolean value, enumerated value, numerical value and character value. For a static information point, several cases of data logic may be set, including: the value of the static information point is null or non-null; the value of the static information point is “yes” or “no” when the attribute of the static information point is Boolean value; the value of the static information point is k or is not k (k is the enumerated item code of the enumerated value) when the attribute of the static information point is enumerated value; the value of the static information point may be equal to A, not equal to A, larger than A, larger than or equal to A, smaller than A, smaller than or equal to A, larger than A and smaller than B, larger than or equal to A and smaller than B, larger than A and smaller than or equal to B, or larger than or equal to A and smaller than or equal to B (A and B are given numerical values) when the attribute of the static information point is numerical value; the value of the static information point is including C or not including C (C is a given string) when the attribute of the static information point is character value. Multiple information point screening conditions may be set for the physical object represented by a graphic element, and these conditions may be logically combined with “AND”, “OR” and “NOT” to form an overall screening and discrimination condition.

In an optional but not limited implementation, the step in which the attachment information in the logical topology diagram is generated according to the target attachment data and the connecting line information of the graphic elements includes steps B1 and B2.

In step B1, an attachment type is determined according to the target attachment data and the connecting line information of the graphic elements, where the attachment type includes a primary device accessory attachment and a trunk attachment, the primary device accessory attachment has a connection relationship with a graphic element, and the trunk attachment has connection relationships with at least two graphic elements.

In step B2, attachment position information is determined according to the target attachment data and the connecting line information of the graphic elements based on the attachment type.

In an embodiment of the present application, in general, attachments may be divided into two types: one type is primary device accessory attachments, and the other one is trunk attachments.

Based on the computation performed according to set relationships between graphic elements, an attachment only connected to a graphic element instance is recognized as a primary device accessory attachment, the device corresponding to the graphic element instance connected to the primary device accessory attachment is a primary device, and an attachment having connection relationships with multiple graphic element instances is referred to as a trunk attachment.

FIG. 2 is a diagram showing the logic for recognizing attachment relationships. Water pumps 1, 2 and 3 and water tanks 1 and 2 are primary devices. On water supply connection relationships between the water pumps and the water tanks, valves 1, 2 and 3, a flow meter and pressure gauges 1 and 2 sequentially exist. From the connection relationships, it can be seen that valves 1, 2 and 3 have a one-to-one correspondence to water pumps 1, 2 and 3, pressure gauges 1 and 2 have a one-to-one correspondence water tanks 1 and 2, and the flowmeter is connected to water pumps 1, 2 and 3 and water tanks 1 and 2 in common. Therefore, it is determined that the valves 1, 2 and 3 are primary device accessory attachments and are attached to water pumps 1, 2 and 3 respectively; the pressure gauges 1 and 2 are primary device accessory attachments and are attached to water tanks 1 and 2 respectively; the flowmeter is a trunk attachment and should be on the common connecting line between the water pumps and the water tanks.

Attachment positioning is determined according to the target attachment obtained after screening and connection relationships between graphic elements, line trend and position information of connecting lines, auxiliary lines and merged connecting lines in the logical topology diagram.

In principle, positioning of the primary device accessory attachment is close to the primary device. The specific layout logic includes the content described below.

The attachment is close to the primary device, and the distance between the attachment and the primary device is a fixed value.

If multiple accessory attachments exist on the same relationship, the multiple accessory attachments are arranged in order with fixed spacing between each other.

For the connection relationship where the attachment is located on, the connection relationship corresponds to an anchor point of the primary device, and the attachment is located in the extension direction of the anchor point. That is, if the connecting anchor point is on the left side, the corresponding attachment is placed in an extension direction towards left, and the same applies to the cases where the connecting anchor point is on other sides (such as on the right side, the upper side or the lower side).

It is to be noted that physical objects represented by each type of graphic elements have points that can be connected, which are referred to as anchor points. Connection between anchor points represents the connection logic between physical objects.

In a positioning principle, the trunk attachments are evenly distributed on the common connecting line, and the specific layout logic includes the content described below.

Connecting lines between graphic elements will be merged into merged connecting lines in the common part, and the trunk attachment is located on a merged connecting line of the corresponding level, that is, the graphic element of the attachment has a corresponding relationship with connecting line segments. As shown in FIG. 3, the flowmeter is a trunk attachment, and the corresponding merged connecting lines are two short transverse lines on two sides of the graphic element of the flowmeter.

Attachments corresponding to a connecting line segment are evenly distributed and located on the line segment.

Attachments corresponding to a connection line segment group are evenly distributed and located on the longest line segment in the line segment group.

In an optional but not limited implementation, the step in which the attachment position information is determined according to the target attachment data and the connecting line information of the graphic elements based on the attachment type includes steps C1 and C2.

In step C1, if the attachment type is the primary device accessory attachment, a target graphic element corresponding to the attachment is determined according to the target attachment data, and the attachment position information is determined on a direct connecting line of the target graphic element according to the number of attachments and the order of the attachments.

In step C2, if the attachment type is the trunk attachment, at least two target graphic elements corresponding to the trunk attachment are determined according to the target attachment data, and the attachment position information is determined on a common connecting line of the at least two target graphic elements according to the number of attachments and the order of the attachments.

In the embodiment of the present application, the target attachment is determined according to the screening condition, the target attachment data includes attachments matching the physical world data and the number of attachments, and attachment spacing is set according to the number of attachments. If the attachments are primary device accessory attachments, the order and positions of the primary device accessory attachments on graphic element connecting lines are determined according to the connection order of devices in the physical world data; if the attachments are trunk attachments, the order and positions of the trunk attachments on the common connecting line of two target graphic elements are determined according to the connection order of devices in the physical world data.

When multiple attachments exist on a connecting line segment or a connecting line segment group, the order of positioning of the attachments is determined according to the order of connection relationships. FIG. 3 is a diagram showing water supply connection relationships of water pump water supply pipelines. For example, the water pump water supply pipeline is sequentially connected to valves and pressure gauges. In the water supply connection relationship data, the connection relationships are pump-valve and valve-pressure gauge. Therefore, the order of accessory valves and pressure gauges connected to the water pumps is determined by these connection relationships, that is, starting from connecting anchor points of the water pumps for water supply, graphic elements used for representing valves are first connected, and then graphic elements used for representing pressure gauges are connected.

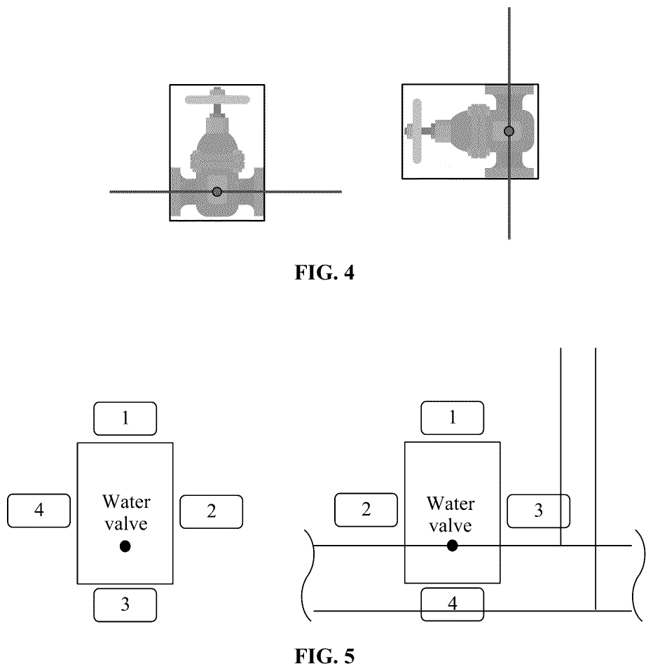

It is to be noted that the graphic element corresponding to each attachment has a positioning point of the attachment. When the attachment is located on the connecting line, it is ensured that the positioning point is on the connecting line. The positioning point may not be the rectangular center point of the graphic element of the attachment, and may have an offset in relative to the rectangular center point depending on device features corresponding to the attachment. FIG. 4 is a diagram showing dual application of positioning of the attachment of the graphic element representing a valve. The solid dot in FIG. 4 represents the positioning point of the graphic element of the attachment, and the long segment represents a certain connecting line in the logical topology diagram. The graphic element corresponding to the attachment does not differ due to different device models, but to adapt to transverse line segments and longitudinal line segments, a pair of graphic elements are provided. One graphic element is used for location on transverse line segments, and the other graphic element is used for location on longitudinal line segments. During instantiation, the selection is performed based on the transverse or longitudinal case of the line segment in the layout.

In an optional but not limited implementation, after the step in which the attachment position information is determined according to the target attachment data and the connecting line information of the graphic elements, the method further includes steps D1 and D2.

In step D1, corresponding candidate text display regions are determined according to the attachment position information.

In step D2, a target text display region is determined according to unoccupied areas of the candidate text display regions, priority of the candidate text display regions and the amount of text.

In the embodiment of the present application, the text corresponding to the attachment is used for representing the explanatory information of the attachment, and the amount of text is determined according to the personalized display needs of the user. The graphical element of the attachment displayed in the final logical topology diagram is relatively small, less additional text information needs to be displayed, and no strict requirement exists for the display position of the text information. Thus, the text position of the attachment is relatively free and flexible. FIG. 5 is a diagram of a text display region. The text display has the characteristics described below.

The graphic element corresponding to each attachment has several, generally four, candidate regions for text display, that is, one on the top of the rectangular frame, one on the bottom of the rectangular frame, one on the left of the rectangular frame and one on the right of the rectangular frame.

After layout positioning of the attachment is completed, discrimination between sizes of blanks at the four directions is performed, and the four blanks are sequenced in descending order of unoccupied areas according to occupied areas of the candidate text regions.

When unoccupied areas of two text regions are the same, the two text regions are sequenced according to the counterclockwise direction. If the graphic element of the attachment is a transverse graphic element, the position directly above the graphic element is taken as a start point; if the graphic element of the attachment is a longitudinal graphic element, the position at the center of the left side is taken as a start point.

Text regions are sequentially used according to the preceding order.

In an optional but not limited implementation, after the step in which the attachment information in the logical topology diagram is generated according to the template attachment information in the target relationship diagram template and the connecting line information of the graphic elements, the method further includes steps E1 to E3.

In step E1, attachment calling display information of the logical relationship topology diagram is acquired.

In step E2, a hidden attachment in the logical relationship topology diagram is determined according to a hidden accessory device type in the attachment calling display information and hidden attachment connection logic in the attachment calling display information.

In step E3, the attachment information in the logical topology diagram is displayed based on the hidden attachment.

In the embodiment of the present application, the attachment calling display information refers to a personalized display setting condition of the user. The accessory device type, that is, the attachment type, includes a primary device accessory attachment and a trunk attachment, and the attachment connection logic represents physical connection relationships between the attachment and other physical objects and is determined by anchor point connection relationships on the graphic element for representing the attachment. The user may specify that attachments of a certain type of devices are not displayed, or that attachments on a certain anchor connection relationship are not displayed. Typesetting of the logical topology diagram is automatically adjusted according to the display or hiding setting, that is, whether the attachment is displayed or hidden. The user specifies the amount of accessory text of the attachment, and the logical topology diagram displays a reserved text region in the preceding order according to the amount of text.

The present disclosure discloses the method for generating an attachment in a logical topology diagram. The method includes the steps described below. Physical world data of a target building is acquired, and a target relationship diagram template is determined from pre-built candidate relationship diagram templates according to the physical world data and a topology diagram generation requirement; connecting line information of a graphic element in the logical topology diagram is determined according to the target relationship diagram template; and attachment information in the logical topology diagram is generated according to template attachment information in the target relationship diagram template and the connecting line information of the graphic elements. According to the technical solutions of the present disclosure, the attachment type in the logical topology diagram is determined based on the relationship level classification, the positioning point of the attachment in the logical topology diagram is determined according to the information related to the attachment, and then positioning of the attachment in the logical topology diagram is implemented.

### Embodiment Two

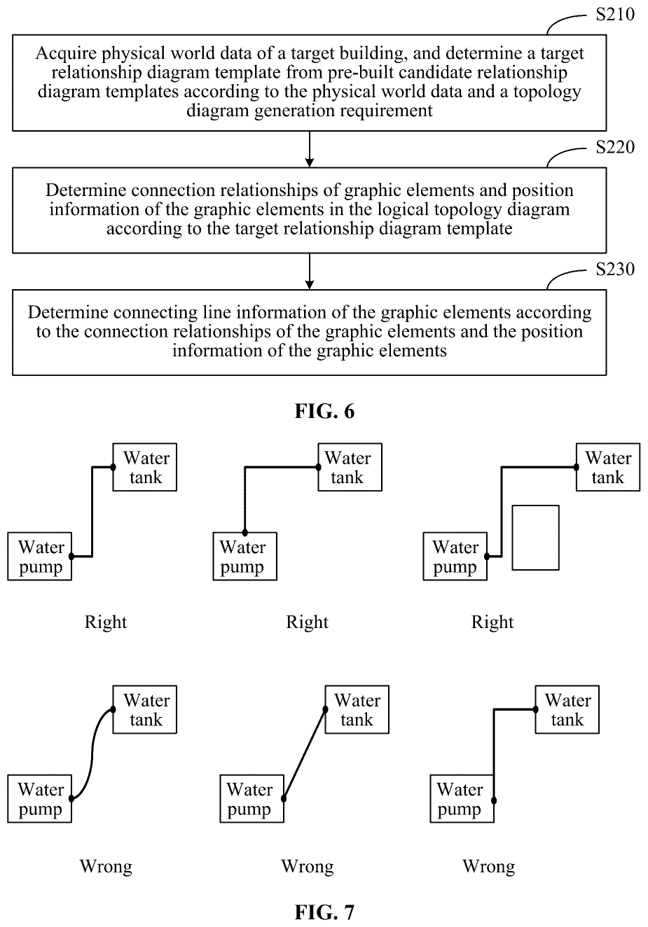

FIG. 6 is a flowchart of a line connection method of graphic elements in a logical topology diagram according to an embodiment of the present disclosure. The embodiment is applicable to the case of line connection between graphic elements in a logical topology diagram. The connecting line information of the graphic elements in the logical topology diagram determined according to the target relationship diagram template in the preceding embodiment may be described in detail. As shown in FIG. 6, the method includes the steps described below.

In S210, physical world data of a target building is acquired, and a target relationship diagram template is determined from pre-built candidate relationship diagram templates according to the physical world data and a topology diagram generation requirement, where the physical world data includes at least complete relationship representation information of spaces, systems and devices in the target building.

In the embodiment of the present application, the target building refers to a specific building entity in the engineering field. The physical world data of the target building may be understood as the digital form of the target building and refers to the complete expression of objective physical information of a physical building, including spaces, systems, device objects, information points and relationship data in the physical building. The complete relationship representation information of devices includes two aspects, that is, device object information points and connection relationship data of device objects, respectively.

It is to be noted that the topology diagram generation requirement refers to the type of the logical topology diagram to be generated according to the needs of the user. The layout and display parameters of the logical topology diagram are part of the personalized display requirement of the generation requirement, including an image dimension requirement and whether a graphic element is specified to be displayed or hidden.

Candidate relationship diagram templates are standardized representation of a certain type of electromechanical systems and devices, including professional attribute information on the composition, connection relationships and layout expression of specific electromechanical systems. This type of candidate relationship diagram templates are pre-stored in a database by the system for calling, and a target relationship diagram template type is determined from the candidate relationship diagram templates according to the specific data of the target building and the layout and display parameters of the topology diagram.

In S220, connection relationships of graphic elements and position information of the graphic elements in the logical topology diagram are determined according to the target relationship diagram template.

In the embodiment of the present application, connection relationships of graphic elements in the logical topology diagram are used for representing physical connection relationships between physical objects in the physical world data, and connection relationships of graphic elements are represented by polylines in the logical topology diagram. The position information of the graphic elements in the logical topology diagram includes relative position information between the graphic elements and attribute information of the graphic elements, and thereby final positions of the graphic elements in the logical topology diagram are determined as the positioning result of each graphic element. The relative position information of the graphic elements includes the layout manner of the graphic elements. If the graphic elements are transversely laid out, longitudinal positions (including top alignment, bottom alignment and center alignment) of the graphic elements may be set. If the graphic elements are longitudinally laid out, transverse positions (including left alignment, right alignment and center alignment) of the graphic elements may be set. The relative position information of the graphic elements further includes setting the spacing length between the graphic elements. In addition, the attribute information of the graphic elements includes physical objects to which the graphic elements belong and the number of physical objects.

In S230, connecting line information of the graphic elements is determined according to the connection relationships of the graphic elements and the position information of the graphic elements.

In the embodiment of the present application, graphic elements are represented by rectangles of various sizes, representing different physical objects such as devices, systems and spaces. The graphic elements are connected by polylines, and these polylines represents pipelines, line connection relationships or subordination relationships between the graphic elements. The position information of each graphic element in the target relationship diagram template is laid out and typeset relative to other graphic elements, and the final positioning result of the position information is relative position relationships between graphic elements. Line connection is performed between various graphic elements in the entire template with the shortest path as the main logic for connecting line layout in blank regions between graphic elements through the determined relative position relationships and connection relationships of graphic elements.

Physical objects represented by each type of graphic elements have points that can be connected, which are referred to as anchor points. Connection between anchor points represent physical relationships between physical objects. The basic line connection logic between graphic elements includes: the line connection only occurs between anchor points of graphic elements; connecting lines are a group of horizontal and vertical line segments; a connecting line follows the shortest path and the least number of turns in the line segment group between two points; the connecting line between two anchor points should avoid other graphic elements along the path; an end point of a line segment is connected to the position of an anchor point, the direction of the line segment is related to the position of the anchor point, and the minimum extension distance is retained. If the anchor point is at the top, the line segment extends upwards; if the anchor point is at the bottom, the line segment extends downwards; if the anchor point is on the left, the line segment extends to the left; if the anchor point is on the right, the line segment extends to the right. FIG. 7 is a diagram showing right and wrong line connection logic.

In an optional but not limited implementation, the step in which the connecting line information of the graphic elements is determined according to the connection relationships of the graphic elements and the position information of the graphic elements includes steps F1 and F2.

In step F1, whether at least two connecting lines exist between two graphic elements is determined according to the connection relationships of the graphic elements and the position information of the graphic elements.

In step F2, if the at least two connecting lines exist, position information of the at least two connecting lines is determined according to an order of determining connecting lines based on minimum line spacing.

It is to be noted that when multiple path lines exist between two graphic elements, to ensure that these lines do not overlap, the routing logic of the multiple path lines includes the content described below.

If multiple longitudinal path lines exist between two graphic elements, the multiple longitudinal path lines are evenly arranged from the left to the right and evenly distributed in the blank region between the left graphic element and the right graphic element.

If multiple transverse path lines exist between two graphic elements, the multiple transverse path lines are evenly arranged from the top to the bottom and evenly distributed in the blank region between the upper graphic element and the lower graphic element.

If multiple left graphic elements and right graphic elements exist, the blank region is taken from the right edge of the left side graphic element set to the left edge of the right side graphic element set.

If multiple upper graphic elements and lower graphic elements exist, the blank region is taken from the lower edge of the upper graphic element set to the upper edge of the lower graphic element set.

Transverse path lines or longitudinal path lines equally divide the blank region, and the spacing obtained after equal division cannot be less than the minimum line spacing. If the spacing is less than the minimum line spacing, the region is set as an impassable region for some routes.

FIG. 8 is a diagram showing multiple graphic elements on the left and the right and multiple path lines. The blank region is taken from the right edge of the left side graphic element set to the left edge of the right side graphic element set. In FIG. 8, the longitudinal blank region is represented by dashed lines. Multiple longitudinal path lines exist between graphic elements, and the multiple longitudinal path lines are evenly arranged from the left to the right and evenly distributed in the blank region between the left graphic element set and the right graphic element set.

In an optional but not limited implementation, the step in which the connecting line information of the graphic elements is determined according to the connection relationships of the graphic elements and the position information of the graphic elements includes steps G1 and G2.

In step G1, whether auxiliary line information corresponding to the graphic element exists is determined, where the auxiliary line information is pre-annotated in the target relationship diagram template.

In step G2, if the auxiliary line information exists, the connecting line information of the graphic elements is determined according to the connection relationships of the graphic elements and the position information of the graphic elements based on the auxiliary line information.

In the embodiment of the present application, for some relatively complex graphic layout, using the shortest paths may lead to a large number of line intersections, which may make it difficult to distinguish the paths of the lines. In view of this, auxiliary lines are set, that is, auxiliary lines are used for constraining the directions of lines at the position of local special graphic layout. The auxiliary lines have the characteristics described below.

The auxiliary lines can only be horizontal and vertical, and may be multiple segments of polylines.

The auxiliary lines must indicate types of relationships that the auxiliary lines represent, that is, indicate which specified connection relationships between graphic elements.

Multiple connection relationships may share auxiliary lines, that is, share special routing directions, and may still be instantiated as multiple connecting lines during instantiation.

Auxiliary lines may refer to certain special device objects, such as distribution busbars.

When directions of lines are determined, auxiliary lines take precedence over merged connecting lines and over ordinary connecting lines.

In an optional but not limited implementation, the auxiliary line information includes position information of an auxiliary line, a reference edge of a graphic element corresponding to the auxiliary line and reference points of the graphic element corresponding to a start point, an end point and an inflection point of the auxiliary line.

In an embodiment, drawing of auxiliary lines has the characteristics described below.

The drawing of auxiliary lines requires specifying the reference points and reference edges related to the graphic elements of the connection relationships carried by the auxiliary lines, so the generation of actual auxiliary lines is guided.

Reference points need to be specified in the target relationship diagram template for the start point, the end point and the inflection point of the auxiliary line. The reference points are used for specifying the start point and the end point for the growth of each line segment of the auxiliary line.

A reference edge needs to be specified in the target relationship diagram template for each line segment of auxiliary lines. The reference edge is used for specifying the start boundary of drawing auxiliary lines when multiple auxiliary lines are generated.

Multiple auxiliary lines are drawn according to the connection situation of devices in the actual physical world.

Excess ends of lines need to be cut off, that is, the part of the auxiliary line that is not passed by actual connecting lines needs to be cut off.

In an optional but not limited implementation, the step in which the connecting line information of the graphic elements is determined according to the connection relationships of the graphic elements and the position information of the graphic elements based on the auxiliary line information includes steps H1-H3.

In step H1, connecting anchor points are determined according to the connection relationships of the graphic elements.

In step H2, edges in which the connecting anchor points are located are determined as target reference edges, and corresponding target auxiliary lines are determined according to the target reference edges.

In step H3, position information of connecting lines between the connecting anchor points is determined according to target auxiliary line information and the position information of the graphic elements.

In the embodiment of the present application, the specific position of the connecting anchor point on the rectangle for representing the graphic element is determined according to the connection information of the graphic element, the edge where the specific position is located is set as the target reference edge and the corresponding target auxiliary line is determined, and the specific connecting line position information is determined according to the preceding line connection logic and the drawing of the auxiliary line.

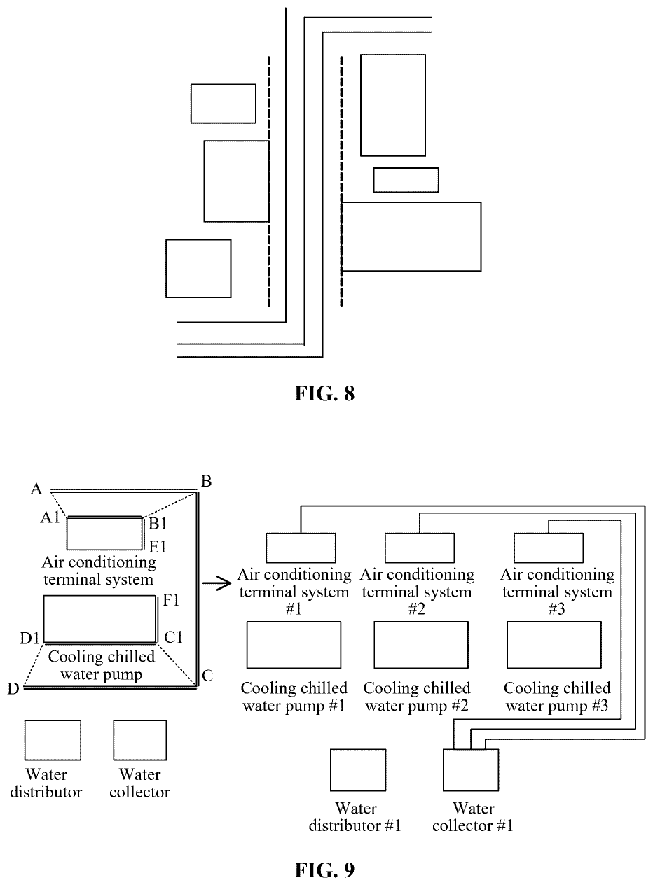

In an embodiment, to better understanding the drawing of the auxiliary line, the embodiment illustrates an example. FIG. 9 is a diagram showing the process of drawing an auxiliary line. For example, the auxiliary line is drawn along A-B-C-D, carrying the chilled water return relationship from an water collector to an air conditioning terminal system. It is set that reference point A corresponds to A1, reference point B corresponds to B1, reference point C corresponds to C1, and reference point D corresponds to D1, and it is set that reference edge A-B corresponds to A1-B1, reference edge B-C corresponds to B1-E1 and F1-C1, and reference edge C-D corresponds to C1-D1.

In the first step, the actual generation logic of line segments A-B, B-C and C-D of the auxiliary line is described below.

The length of line segment A-B grows from the upper left corner vertex of air conditioning terminal system 1 to the upper right corner vertex of air conditioning terminal system #3 in the right figure of FIG. 9.

The length of line segment B-C grows from the upper right corner vertex of air conditioning terminal system 3 to the lower right corner vertex of cooling chilled water pump #3 in the right figure of FIG. 9.

The length of line segment C-D grows from the lower right corner vertex of cooling chilled water pump #3 to the lower left corner vertex of cooling chilled water pump #1 in the right figure of FIG. 9.

In the second step, the generation logic of multiple auxiliary lines includes determination according to connection relationships of actual devices. Air conditioning terminal system #1, air conditioning terminal system #2 and air conditioning terminal system #3 are connected to three anchor points of water collector #1 respectively, so three auxiliary lines are actually generated.

In the third step, excess ends of lines are cut off, then according to actual connecting lines, auxiliary lines that are not passed by actual connecting lines are cut off, and thus final auxiliary lines are generated.

After whether the corresponding auxiliary line information exists for the graphic element is determined, the method further includes the step described below.

If no corresponding auxiliary line information exists, the connecting line information of the graphic elements is determined according to the connection relationships of the graphic elements and the position information of the graphic elements.

In an optional but not limited implementation, the step in which the connecting line information of the graphic elements is determined according to the connection relationships of the graphic elements and the position information of the graphic elements includes steps I1 and I2.

In step I1, whether another graphic element corresponding to the graphic element exists, where the another graphic element has the same connection relationship as the graphic element and is connected to the same connected object as the graphic element is determined.

In step I2, if the another graphic element exists, a connecting line between the graphic element and the same connected object and a connecting line between the another graphic element and the same connected object are merged in a common connection part.

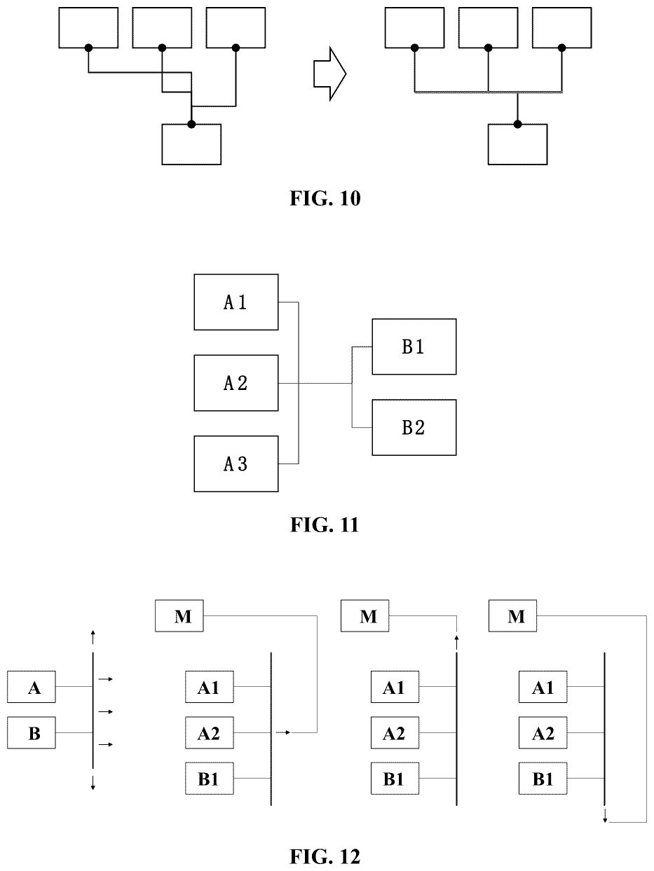

In the embodiment of the present application, having the same connection relationship and being connected to the same connected object may refer to being connected to a graphic element or to a graphic element set. When a graphic element is connected to multiple connected objects simultaneously, parallel connection occurs on connection relationships. Connecting lines between the graphic element and the multiple connected objects may be merged so that merged connecting lines are generated, and thus connecting lines are simplified. FIG. 10 is a diagram showing the connection of merged connecting lines.

If no graphic element which has the same connection relationship as the graphic element and is connected to the same connected object as the graphic element exists, and only one connecting line exists for each pair of graphic elements, the line connection is performed according to the preceding line connection logic.

In the embodiment of the present application, the logic for determining merged connecting lines includes the content described below.

FIG. 11 is another diagram showing the connection of merged connecting lines. Physical object entity sets A1, A2, . . . and Am corresponding to a graphic element are connected to physical object entity sets B1, B2, . . . and Bn corresponding to another graphic element using the same relationship R.

Objects entity sets connected to A1 through relationship R are B1 and B2.

Object entity sets connected to A2 and A3 through relationship R are also B1 and B2; it is indicated that A1, A2 and A3 are in a parallel relationship.

As a result, connecting lines of A1, A2 and A3 will be merged into a line segment. Referring to FIG. 11, two vertical line segments and the horizontal line segment in the middle are merged connecting lines.

In an embodiment, the routing logic of the merged connecting lines in the embodiment of the present application includes the content described below.

If devices are all on the same side of the merged connecting lines (assuming that the devices are on the left side), outgoing connecting lines do not go on the left side to avoid conflicts with the devices on the left side. FIG. 12 is a routing diagram when devices are on the same side of merged connecting lines.

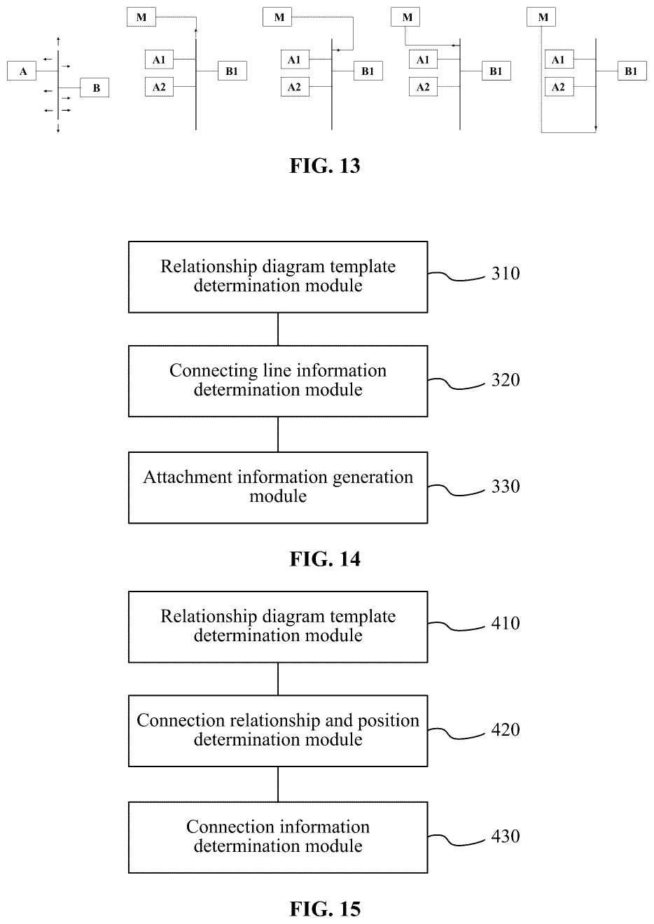

If the devices are located on two sides of the merged connecting lines, directions of outgoing connecting lines are not limited, as conflicts with the devices on the two sides will exist. FIG. 13 is a routing diagram when devices are on two sides of merged connecting lines.

If multiple merged connecting lines exist, the merged connecting line having the shortest distance and the least number of turns is chose.

In an optional but not limited implementation, the order of determining connecting lines is determined from a leaf node to a root node according to superior-subordinate relationship between typesetting group nodes in a typesetting group tree corresponding to the target relationship diagram template, where the typesetting group nodes include at least one graphic element.

In the embodiment of the present application, the typesetting group refers to a typesetting element that combines multiple graphic elements and sets relative positions of these graphic elements. The typesetting group may be multilevel nested, and the number of levels is not limited. That is, a typesetting group may include multiple other typesetting groups or a single graphic element, thus the overall typesetting result is a “typesetting group tree”. The “typesetting group tree” is a tree structure diagram composed of multiple typesetting groups. The “typesetting group tree” is predefined according to position information of graphic elements in the relationship diagram template. Each node in the typesetting group tree represents a typesetting group. The root node of the typesetting group tree is used for representing the canvas of the relationship diagram template, and leaf nodes are used for representing each graphic element. The order of determining connecting lines of graphic elements in the logical topology diagram is from graphic elements to a graphic element set and then to the root node of the canvas.

Exemplarily, connecting line information in the typesetting group corresponding to the leaf nodes is determined according to the superior-subordinate relationship between the typesetting group nodes in the typesetting group tree, and then connecting line information corresponding to upper-level nodes of the leaf nodes is determined. If the connecting line information corresponding to the upper-level nodes conflicts with the connecting line information corresponding to the lead nodes, connecting line information needs to be determined in combination with the overall information of graphic elements included in the typesetting groups corresponding to the upper-level nodes and the lead nodes until the connecting line information of the root node is determined.

The embodiment discloses the line connection method of graphic elements in a logical topology diagram. The method includes the steps described below. Physical world data of a target building is acquired, and a target relationship diagram template is determined from pre-built candidate relationship diagram templates according to the physical world data and a topology diagram generation requirement; connection relationships of graphic elements and position information of the graphic elements in the logical topology diagram are determined according to the target relationship diagram template; the connecting line information of the graphic elements is determined according to the connection relationships of the graphic elements and the position information of the graphic elements. According to the technical solutions of the present disclosure, connecting lines are logically divided into three levels, that is, ordinary connecting lines, merged connecting lines and auxiliary lines. The shortest path is used as the main logic for automatic connecting line layout, so the connecting line layout of graphic elements in the logical topology diagram can be quickly determined.

### Embodiment Three

FIG. 14 is a structural diagram of an apparatus for generating an attachment in a logical topology diagram according to an embodiment of the present disclosure. As shown in FIG. 14, the apparatus includes a relationship diagram template determination module 310, a connecting line information determination module 320 and an attachment information generation module 330.

The relationship diagram template determination module 310 is configured to acquire physical world data of a target building, and determine a target relationship diagram template from pre-built candidate relationship diagram templates according to the physical world data and a topology diagram generation requirement, where the physical world data includes at least complete relationship representation information of spaces, systems and devices in the target building.

The connecting line information determination module 320 is configured to determine connecting line information of graphic elements in the logical topology diagram according to the target relationship diagram template.

The attachment information generation module 330 is configured to generate attachment information in the logical topology diagram according to template attachment information in the target relationship diagram template and the connecting line information of the graphic elements, where the attachment refers to a graphic element attached to a connecting line of at least two graphic elements of the graphic elements and is used for representing an accessory device on a connecting pipeline between physical objects corresponding to the at least two graphic elements.

Optionally, the attachment information generation module 330 includes an attachment data determination unit and an attachment information generation unit.

The attachment data determination unit is configured to determine matched target attachment data from the physical world data according to an attachment screening condition in the template attachment information in the target relationship diagram template.

The attachment information generation unit is configured to generate the attachment information in the logical topology diagram according to the target attachment data and the connecting line information of the graphic elements.

Optionally, the attachment screening condition includes a static information point screening condition. The static information point screening condition includes at least one of the following logical combinations of data logic: an information point value being null or non-null, an information point value being a Boolean value, an information point value being an enumerated value, an information point value being a numerical value or an information point value being a character value.

Optionally, the attachment information generation unit performs the steps described below.

An attachment type is determined according to the target attachment data and the connecting line information of the graphic elements, where the attachment type includes a primary device accessory attachment and a trunk attachment, the primary device accessory attachment has a connection relationship with a graphic element, and the trunk attachment has connection relationships with at least two graphic elements.

Attachment position information is determined according to the target attachment data and the connecting line information of the graphic elements based on the attachment type.

Optionally, the step in which the attachment position information is determined according to the target attachment data and the connecting line information of the graphic elements based on the attachment type includes the steps described below.

In a case where the attachment type is the primary device accessory attachment, a target graphic element corresponding to the attachment is determined according to the target attachment data, and the attachment position information on a direct connecting line of the target graphic element is determined according to the number of attachments and the order of the attachments.

In a case where the attachment type is the trunk attachment, at least two target graphic elements corresponding to the attachment are determined according to the target attachment data, and the attachment position information on a common connecting line of the at least two target graphic elements is determined according to the number of attachments and the order of the attachments.

Optionally, the attachment information generation module further includes a display region determination unit. The display region determination unit is configured to perform the steps described below.

Corresponding candidate text display regions are determined according to the attachment position information.

A target text display region is determined according to unoccupied areas of the candidate text display regions, priority of the candidate text display regions and the amount of text.

Optionally, the attachment information generation module further includes a display unit. The display unit is configured to perform the steps described below.

Attachment calling display information of the logical relationship topology diagram is acquired.

A hidden attachment in the logical relationship topology diagram is determined according to a hidden accessory device type in the attachment calling display information and hidden attachment connection logic in the attachment calling display information.

The attachment information in the logical topology diagram is displayed based on the hidden attachment.

Optionally, the connecting line information determination module includes a connection relationship and position determination unit and a connection information determination unit.

The connection relationship and position determination unit is configured to determine a connection relationship of a graphic element and position information of the graphic elements in the logical topology diagram according to the target relationship diagram template.

The connection information determination module is configured to determine connecting line information of the graphic elements according to the connection relationships of the graphic elements and the position information of the graphic elements.

Optionally, the connection information determination unit includes an auxiliary line discrimination unit and a connecting line information determination unit.

The auxiliary line discrimination unit is configured to determine whether auxiliary line information corresponding to the graphic element exists, where the auxiliary line information is pre-annotated in the target relationship diagram template.

The connecting line information determination module is configured to, in a case where the auxiliary line information exists, determine, based on the auxiliary line information, the connecting line information of the graphic elements according to the connection relationships of the graphic elements and the position information of the graphic elements.

Optionally, the auxiliary line information includes position information of an auxiliary line, a reference edge of a graphic element corresponding to the auxiliary line and reference points of the graphic elements corresponding to a start point, an end point and an inflection point of the auxiliary line.

Optionally, the connecting line information determination unit performs the steps described below.

Connecting anchor points are determined according to the connection relationships of the graphic elements.

Edges in which the connecting anchor points are located is determined as target reference edges, and corresponding target auxiliary lines are determined according to the target reference edges.

Position information of connecting lines between the connecting anchor points are determined according to target auxiliary line information and the position information of the graphic elements.

Optionally, the connection information determination unit further includes a same connection relationship discrimination unit and a connecting line merging unit.

The same connection relationship discrimination unit is configured to determine whether another graphic element corresponding to a graphic element of the graphic elements exists, where the another graphic element has the same connection relationship as the graphic element and is connected to the same connected object as the graphic element.

The connecting line merging unit is configured to, in a case where the another graphic element exists, merge a connecting line between the graphic element and the same connected object and a connecting line between the another graphic element and the same connected object in a common connection part.

Optionally, the connection information determination unit further includes a connecting line discrimination unit and a connecting line position determination unit.

The connecting line discrimination unit is configured to determine whether at least two connecting lines exist between two graphic elements according to the connection relationships of the graphic elements and the position information of the graphic elements.

The connecting line position determination unit is configured to, in a case where the at least two connecting lines exist, determine, based on minimum line spacing, position information of the at least two connecting lines according to an order of determining connecting lines.

Optionally, the order of determining connecting lines is determined from a leaf node to a root node according to superior-subordinate relationship between typesetting group nodes in a typesetting group tree corresponding to the target relationship diagram template, where the typesetting group nodes include at least one graphic element.

The apparatus for generating an attachment in a logical topology diagram provided in the embodiment of the present disclosure may perform the method for generating an attachment in a logical topology diagram provided in any embodiment of the present disclosure and has function modules and beneficial effects corresponding to the method performed.

In the technical solutions of the present application, the acquisition, storage, use and processing of data are in compliance with relevant provisions of national laws and regulations and do not violate public order and good customs.

### Embodiment Four

FIG. 15 is a structural diagram of a line connecting apparatus of graphic elements in a logical topology diagram according to embodiment two of the present disclosure. As shown in FIG. 15, the apparatus includes a relationship diagram template determination module 410, a connection relationship and position determination module 420 and a connection information determination module 430.

The relationship diagram template determination module 410 is configured to acquire physical world data of a target building, and determine a target relationship diagram template from pre-built candidate relationship diagram templates according to the physical world data and a topology diagram generation requirement, where the physical world data includes at least complete relationship representation information of spaces, systems and devices in the target building.

The connection relationship and position determination module 420 is configured to determine connection relationships of graphic elements and position information of the graphic elements in the logical topology diagram according to the target relationship diagram template.

The connection information determination module 430 is configured to determine connecting line information of the graphic elements according to the connection relationships of the graphic elements and the position information of the graphic elements.

Optionally, the connection information determination module includes an auxiliary line discrimination unit and a connecting line information determination unit.

The auxiliary line discrimination unit is configured to determine whether auxiliary line information corresponding to the graphic element exists, where the auxiliary line information is pre-annotated in the target relationship diagram template.

The connecting line information determination module is configured to, in a case where the auxiliary line information exists, determine, based on the auxiliary line information, the connecting line information of the graphic elements according to the connection relationships of the graphic elements and the position information of the graphic elements.

Optionally, the auxiliary line information includes position information of an auxiliary line, a reference edge of a graphic element corresponding to the auxiliary line and reference points of the graphic element corresponding to a start point, an end point and an inflection point of the auxiliary line.

Optionally, the connecting line information determination unit performs the steps described below.

Connecting anchor points are determined according to the connection relationships of the graphic elements.

Edges in which the connecting anchor points are located are determined as target reference edges, and corresponding target auxiliary lines are determined according to the target reference edges.

Position information of connecting lines between the connecting anchor points is determined according to target auxiliary line information and the position information of the graphic elements.

Optionally, the connection information determination module further includes a same connection relationship discrimination unit and a connecting line merging unit.

The same connection relationship discrimination unit is configured to determine whether another graphic element corresponding to a graphic element of the graphic elements exists, where the another graphic element has the same connection relationship as the graphic element and is connected to the same connected object as the graphic element.

The connecting line merging unit is configured to, in a case where the another graphic element exists, merge a connecting line between the graphic element and the same connected object and a connecting line between the another graphic element and the same connected object in a common connection part.

Optionally, the connection information determination module further includes a connecting line discrimination unit and a connecting line position determination unit.

The connecting line discrimination unit is configured to determine whether at least two connecting lines exist between two graphic elements according to the connection relationships of the graphic elements and the position information of the graphic elements.

The connecting line position determination unit is configured to, in a case where the at least two connecting lines exist, determine, based on minimum line spacing, position information of the at least two connecting lines according to an order of determining connecting lines.

Optionally, the order of determining connecting lines is determined from a leaf node to a root node according to superior-subordinate relationship between typesetting group nodes in a typesetting group tree corresponding to the target relationship diagram template, where the typesetting group nodes include at least one graphic element.

The line connecting apparatus of graphic elements in a logical topology diagram provided in the embodiment of the present disclosure may perform the line connection method of graphic elements in a logical topology diagram provided in any embodiment of the present disclosure and has function modules and beneficial effects corresponding to the method performed.

In the technical solutions of the present application, the acquisition, storage, use and processing of data are in compliance with relevant provisions of national laws and regulations and do not violate public order and good customs.

### Embodiment Five

According to an embodiment of the present disclosure, the present disclosure further provides an electronic device, a readable storage medium and a computer program product.

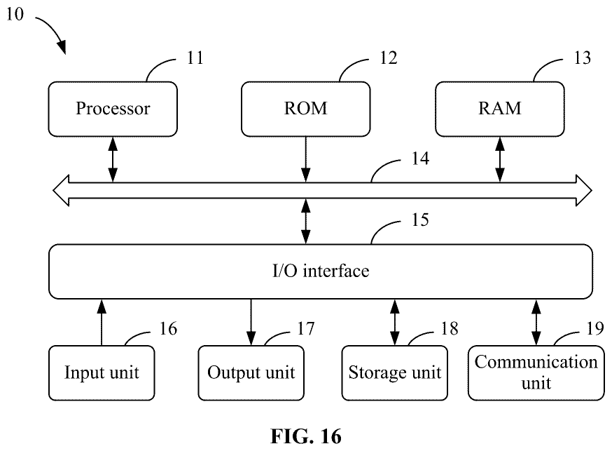

FIG. 16 is a structural diagram of an electronic device 10 for implementing the embodiments of the present disclosure. The electronic device is intended to represent various forms of digital computers, for example, a laptop computer, a desktop computer, a worktable, a personal digital assistant, a server, a blade server, a mainframe computer or another applicable computer. The electronic device may also represent various forms of mobile apparatuses, for example, a personal digital assistant, a cellphone, a smartphone, a wearable device (such as a helmet, glasses and a watch) or another similar computing apparatus. Herein the shown components, the connection and relationships between these components and the functions of these components are illustrative only and are not intended to limit the implementation of the present disclosure as described and/or claimed herein.

As shown in FIG. 16, the electronic device 10 includes at least one processor 11 and a memory (such as a read-only memory (ROM) 12 and a random-access memory (RAM) 13) communicatively connected to the at least one processor 11. The memory stores a computer program executable by the at least one processor, and the at least one processor 11 may perform various types of appropriate operations and processing according to a computer program stored in the ROM 12 or a computer program loaded from a storage unit 18 to the RAM 13. Various programs and data required for the operation of the electronic device 10 may also be stored in the RAM 13. The at least one processor 11, the ROM 12 and the RAM 13 are connected to each other through a bus 14. An input/output (I/O) interface 15 is also connected to the bus 14.

Multiple components in the electronic device 10 are connected to the I/O interface 15. The multiple components include an input unit 16 such as a keyboard or a mouse, an output unit 17 such as various types of displays or speakers, the storage unit 18 such as a magnetic disk or an optical disc, and a communication unit 19 such as a network card, a modem or a wireless communication transceiver. The communication unit 19 allows the electronic device 10 to exchange information/data with other devices over a computer network such as the Internet and/or various telecommunications networks.

The at least one processor 11 may be various general-purpose and/or special-purpose processing assemblies having processing and computing capabilities. Examples of the at least one processor 11 include, but are not limited to, a central processing unit (CPU), a graphics processing unit (GPU), a special-purpose artificial intelligence (AI) computing chip, a processor executing machine learning models and algorithms, a digital signal processor (DSP) and any appropriate processor, controller or microcontroller. The at least one processor 11 performs various methods and processing described above, such as the method for generating an attachment in a logical topology diagram or the line connection method of graphic elements in a logical topology diagram.

In some embodiments, the method for generating an attachment in a logical topology diagram or the line connection method of graphic elements in a logical topology diagram may be implemented as computer programs tangibly contained in a computer-readable storage medium such as the storage unit 18. In some embodiments, part or all of computer programs may be loaded and/or installed onto the electronic device 10 via the ROM 12 and/or the communication unit 19. When the computer programs are to the RAM 13 and executed by the at least one processor 11, one or more steps of the method for generating an attachment in a logical topology diagram or the line connection method of graphic elements in a logical topology diagram described above can be performed. Alternatively, in other embodiments, the at least one processor 11 may be configured, in any other suitable manners (for example, by use of firmware), to perform the method for generating an attachment in a logical topology diagram or the line connection method of graphic elements in a logical topology diagram.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software and/or combinations thereof. The various embodiments may include implementations in one or more computer programs. The one or more computer programs are executable and/or interpretable on a programmable system including at least one programmable processor. The programmable processor may be a dedicated or general-purpose programmable processor for receiving data and instructions from a storage system, at least one input apparatus, and at least one output apparatus and transmitting the data and instructions to the storage system, the at least one input apparatus, and the at least one output apparatus.

Computer programs for implementation of the methods of the present disclosure may be written in one programming language or any combination of multiple programming languages. These computer programs may be provided for a processor of a general-purpose computer, a special-purpose computer, or another programmable data processing apparatus so that the computer programs, when executed by the processor, cause functions/operations specified in the flowcharts and/or block diagrams to be implemented. The computer programs may be executed entirely on a machine, partly on a machine, as a stand-alone software package, partly on a machine and partly on a remote machine, or entirely on a remote machine or a server.

In the context of the present disclosure, the computer-readable storage medium may be a tangible medium including or storing a computer program that is used by or used in conjunction with an instruction execution system, apparatus or device. The computer-readable storage medium may include, but is not limited to, an electronic, magnetic, optical, electromagnetic, infrared or semiconductor system, apparatus or device or any appropriate combination thereof. Alternatively, the computer-readable storage medium may be a machine-readable signal medium. Concrete examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device or any appropriate combination thereof.

In order that interaction with a user is provided, the systems and techniques described herein may be implemented on the electronic device. The electronic device has a display apparatus (for example, a cathode-ray tube (CRT) or a liquid-crystal display (LCD) monitor) for displaying information to the user; and a keyboard and a pointing apparatus (for example, a mouse or a trackball) through which the user can provide input for the electronic device. Other types of apparatuses may also be used for providing interaction with a user. For example, feedback provided for the user may be sensory feedback in any form (for example, visual feedback, auditory feedback or tactile feedback); and input from the user may be received in any form (including acoustic input, voice input or tactile input).

The systems and techniques described herein may be implemented in a computing system including a back-end component (for example, a data server), a computing system including a middleware component (for example, an application server), a computing system including a front-end component (for example, a user computer having a graphical user interface or a web browser through which a user can interact with embodiments of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN), a blockchain network and the Internet.

The computing system may include clients and servers. A client and a server are generally remote from each other and typically interact through a communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a conventional physical host and virtual private server (VPS) services.

It is to be understood that various forms of the preceding flows may be used, with steps reordered, added or removed. For example, the steps described in the present disclosure may be performed in parallel, in sequence or in a different order as long as the desired results of the technical solutions of the present disclosure can be achieved. The execution sequence of these steps is not limited herein.

The preceding embodiments are not intended to limit the scope of the present disclosure. It is to be understood by those skilled in the art that various modifications, combinations, subcombinations and substitutions may be made according to design requirements and other factors. Any modification, equivalent substitution or improvement made within the spirit and principle of the present disclosure falls within the scope of the present disclosure.

What is claimed is:

1. A method for generating an attachment in a logical topology diagram, comprising:
acquiring physical world data of a target building, and determining a target relationship diagram template from pre-built candidate relationship diagram templates according to the physical world data and a topology diagram generation requirement, wherein the physical world data comprises at least complete relationship representation information of spaces, systems and devices in the target building;
determining connecting line information of graphic elements in the logical topology diagram according to the target relationship diagram template; and
generating attachment information in the logical topology diagram according to template attachment information in the target relationship diagram template and the connecting line information of the graphic elements, wherein the attachment refers to a graphic element attached to a connecting line of at least two graphic elements of the graphic elements and is used for representing an accessory device on a connecting pipeline between physical objects corresponding to the at least two graphic elements.

2. The method according to claim 1, generating the attachment information in the logical topology diagram according to the template attachment information in the target relationship diagram template and the connecting line information of the graphic elements comprises:
determining matched target attachment data from the physical world data according to an attachment screening condition in the template attachment information in the target relationship diagram template; and
generating the attachment information in the logical topology diagram according to the target attachment data and the connecting line information of the graphic elements.

3. The method according to claim 2, wherein the attachment screening condition comprises a static information point screening condition, wherein
the static information point screening condition comprises at least one of the following logical combinations of data logic: an information point value being null or non-null, an information point value being a Boolean value, an information point value being an enumerated value, an information point value being a numerical value or an information point value being a character value.

4. The method according to claim 2, wherein generating the attachment information in the logical topology diagram according to the target attachment data and the connecting line information of the graphic elements comprises:
determining an attachment type according to the target attachment data and the connecting line information of the graphic elements, wherein the attachment type comprises a primary device accessory attachment and a trunk attachment, the primary device accessory attachment has a connection relationship with a graphic element, and the trunk attachment has connection relationships with at least two graphic elements; and
determining, based on the attachment type, attachment position information according to the target attachment data and the connecting line information of the graphic elements.

5. The method according to claim 4, wherein determining, based on the attachment type, the attachment position information according to the target attachment data and the connecting line information of the graphic elements comprises:
in a case where the attachment type is the primary device accessory attachment, determining a target graphic element corresponding to the attachment according to the target attachment data, and determining the attachment position information on a direct connecting line of the target graphic element according to a number of attachments and an order of the attachments;
in a case where the attachment type is the trunk attachment, determining at least two target graphic elements corresponding to the attachment according to the target attachment data, and determining the attachment position information on a common connecting line of the at least two target graphic elements according to a number of attachments and an order of the attachments.

6. The method according to claim 4, after determining the attachment position information according to the target attachment data and the connecting line information of the graphic elements, further comprising:
determining corresponding candidate text display regions according to the attachment position information; and
determining a target text display region according to unoccupied areas of the candidate text display regions, priority of the candidate text display regions and an amount of text.

7. The method according to claim 1, after generating the attachment information in the logical topology diagram according to the template attachment information in the target relationship diagram template and the connecting line information of the graphic elements, further comprising:
acquiring attachment calling display information of the logical relationship topology diagram;
determining a hidden attachment in the logical relationship topology diagram according to a hidden accessory device type in the attachment calling display information and hidden attachment connection logic in the attachment calling display information; and
displaying the attachment information in the logical topology diagram based on the hidden attachment.

8. The method according to claim 1, wherein determining the connecting line information of the graphic elements in the logical topology diagram according to the target relationship diagram template comprises:
determining connection relationships of the graphic elements and position information of the graphic elements in the logical topology diagram according to the target relationship diagram template; and
determining the connecting line information of the graphic elements according to the connection relationships of the graphic elements and the position information of the graphic elements.

9. The method according to claim 8, wherein determining the connecting line information of the graphic elements according to the connection relationships of the graphic elements and the position information of the graphic elements comprises:
determining whether auxiliary line information corresponding to the graphic element exists, wherein the auxiliary line information is pre-annotated in the target relationship diagram template; and
in a case where the auxiliary line information exists, determining, based on the auxiliary line information, the connecting line information of the graphic elements according to the connection relationships of the graphic elements and the position information of the graphic elements.

10. The method according to claim 9, wherein the auxiliary line information comprises position information of an auxiliary line, a reference edge of a graphic element corresponding to the auxiliary line and reference points of the graphic elements corresponding to a start point, an end point and an inflection point of the auxiliary line.

11. The method according to claim 10, wherein determining, based on the auxiliary line information, the connecting line information of the graphic elements according to the connection relationships of the graphic elements and the position information of the graphic elements comprises:
determining connecting anchor points according to the connection relationships of the graphic elements;
determining edges in which the connecting anchor points are located as target reference edges, and determining corresponding target auxiliary lines according to the target reference edges; and
determining position information of connecting lines between the connecting anchor points according to target auxiliary line information and the position information of the graphic elements.

12. The method according to claim 8, wherein determining the connecting line information of the graphic elements according to the connection relationships of the graphic elements and the position information of the graphic elements comprises:
determining whether another graphic element corresponding to a graphic element of the graphic elements exists, wherein the another graphic element has a same connection relationship as the graphic element and is connected to a same connected object as the graphic element; and in a case where the another graphic element exists, merging a connecting line between the graphic element and the same connected object and a connecting line between the another graphic element and the same connected object in a common connection part or
determining whether at least two connecting lines exist between two graphic elements of the graphic elements according to the connection relationships of the graphic elements and the position information of the graphic elements; and in a case where the at least two connecting lines exist, determining, based on minimum line spacing, position information of the at least two connecting lines according to an order of determining connecting lines.

13. A line connection method of graphic elements in a logical topology diagram, comprising:
acquiring physical world data of a target building, and determining a target relationship diagram template from pre-built candidate relationship diagram templates according to the physical world data and a topology diagram generation requirement, wherein the physical world data comprises at least complete relationship representation information of spaces, systems and devices in the target building;
determining connection relationships of the graphic elements and position information of the graphic elements in the logical topology diagram according to the target relationship diagram template; and
determining connecting line information of the graphic elements according to the connection relationships of the graphic elements and the position information of the graphic elements.

14. The method according to claim 13, wherein determining the connecting line information of the graphic elements according to the connection relationships of the graphic elements and the position information of the graphic elements comprises:
determining whether auxiliary line information corresponding to the graphic element exists, wherein the auxiliary line information is pre-annotated in the target relationship diagram template; and
in a case where the auxiliary line information exists, determining, based on the auxiliary line information, the connecting line information of the graphic elements according to the connection relationships of the graphic elements and the position information of the graphic elements.

15. The method according to claim 14, wherein the auxiliary line information comprises position information of an auxiliary line, a reference edge of a graphic element corresponding to the auxiliary line and reference points of the graphic element corresponding to a start point, an end point and an inflection point of the auxiliary line.

16. The method according to claim 15, wherein determining, based on the auxiliary line information, the connecting line information of the graphic elements according to the connection relationships of the graphic elements and the position information of the graphic elements comprises:
determining connecting anchor points according to the connection relationships of the graphic elements;
determining edges in which the connecting anchor points are located as target reference edges, and determining corresponding target auxiliary lines according to the target reference edges; and
determining position information of connecting lines between the connecting anchor points according to target auxiliary line information and the position information of the graphic elements.

17. The method according to claim 13, wherein determining the connecting line information of the graphic elements according to the connection relationships of the graphic elements and the position information of the graphic elements comprises:
determining whether another graphic element corresponding to a graphic element of the graphic elements exists, where the another graphic element has a same connection relationship as the graphic element and is connected to a same connected object as the graphic element; and in a case where the another graphic element exists, merging a connecting line between the graphic element and the same connected object and a connecting line between the another graphic element and the same connected object in a common connection part; or
determining whether at least two connecting lines exist between two graphic elements according to the connection relationships of the graphic elements and the position information of the graphic elements; and in a case where the at least two connecting lines exist, determining, based on minimum line spacing, position information of the at least two connecting lines according to an order of determining connecting lines.

18. The method according to claim 17, wherein the order of determining the connecting lines is determined from a leaf node to a root node according to superior-subordinate relationships between typesetting group nodes in a typesetting group tree corresponding to the target relationship diagram template, wherein the typesetting group nodes comprise at least one graphic element of the graphic elements.

19. An electronic device, comprising:
at least one processor; and
a memory communicatively connected to the at least one processor;
wherein the memory stores a computer program executable by the at least one processor, and the computer program is executed by the at least one processor to cause the at least one processor to perform the following steps:
acquiring physical world data of a target building, and determining a target relationship diagram template from pre-built candidate relationship diagram templates according to the physical world data and a topology diagram generation requirement, wherein the physical world data comprises at least complete relationship representation information of spaces, systems and devices in the target building;
determining connecting line information of graphic elements in the logical topology diagram according to the target relationship diagram template; and
generating attachment information in the logical topology diagram according to template attachment information in the target relationship diagram template and the connecting line information of the graphic elements, wherein the attachment refers to a graphic element attached to a connecting line of at least two graphic elements of the graphic elements and is used for representing an accessory device on a connecting pipeline between physical objects corresponding to the at least two graphic elements.

20. An electronic device, comprising:
at least one processor; and
a memory communicatively connected to the at least one processor;
wherein the memory stores a computer program executable by the at least one processor, and the computer program is executed by the at least one processor to cause the at least one processor to perform the method of claim 13.
